(19) United States
(12) Patent Application Publication
(10) Pub. No.: US 2016/0203968 A1
(43) Pub. Date: Jul. 14, 2016

(54) PROBE DISPLACEMENT MEASURING APPARATUS, IONIZATION APPARATUS INCLUDING THE SAME, AND MASS SPECTROMETRY APPARATUS

(71) Applicant: CANON KABUSHIKI KAISHA, Tokyo (JP)

(72) Inventors: Yoichi Otsuka, Neyagawa-shi (JP); Masafumi Kyogaku, Yokohama-shi (JP)

(21) Appl. No.: 14/989,710

(22) Filed: Jan. 6, 2016

(30) Foreign Application Priority Data
Jan. 9, 2015 (JP) 2015-003580

(51) Int. Cl. H01J 49/06; H01J 49/12; H01J 49/04; G01B 11/26

(52) U.S. Cl. CPC H01J 49/061; G01B 11/26; H01J 49/12; H01J 49/0431

(57) ABSTRACT

A probe displacement measuring apparatus includes a cantilever probe, a light irradiation unit configured to irradiate the probe with light, a light receiving element configured to receive reflected light obtained by reflecting light emitted by the light irradiation unit on a surface of the probe as a spot, and a displacement obtaining unit configured to obtain displacement of the probe in accordance with a position of the spot on the light receiving element. The light receiving element has first and second light receiving surfaces divided by a straight division line. An angle defined by a displacement direction of the spot on the light receiving element and the division line is 0° or more and 90° or less.

### BACKGROUND OF THE INVENTION

1. Field of the Invention

The present disclosure relates to a probe displacement measuring apparatus, an ionization apparatus including the probe displacement measuring apparatus, and a mass spectrometry apparatus.

2. Description of the Related Art

A scanning probe microscope (SPM) is an apparatus which observes a surface profile of a sample. The SPM measures a surface profile of a sample by measuring a vertical movement (displacement) of a probe at a time when a surface of the sample is scanned by a cantilever probe.

Examples of a method for measuring displacement of a probe include an optical lever method. In the optical lever method, a probe (a cantilever) is irradiated with a light beam, such as laser light, on an upper surface thereof, and reflected light thereof is detected by a light receiving element capable of detecting an irradiation position of the light beam which is installed in a far location. According to this method, fine displacement of the probe reflected in a fine change of an angle of the reflected light may be acutely detected and measured (refer to Japanese Patent Laid-Open No. 11-271341).

Furthermore, scanning probe electrospray ionization (SPESI) is a method for selectively ionizing a sample included in a fine region on a surface of a sample using a probe. When the SPESI is employed, components included in the sample, such as a sample of a living body, may be ionized for each fine region. Then ions obtained by the ionization are analyzed by a certain analysis method, such as mass spectrometry, so that a distribution of the components of the sample may be visualized (refer to Japanese Patent Laid-Open No. 2013-181840).

In the optical lever method, a two-segment photodiode (PD), a four-segment PD, a position sensitive detector (PSD), or an image sensor, such as a CCD, may be used as the light receiving element. However, among these light receiving elements, a two-segment PD or a four-segment PD is frequently used in terms of a cost of the light receiving element and facilitation of processing on detection signals.

In a general optical lever method using a two-segment PD as disclosed in Japanese Patent Laid-Open No. 11-271341, a position of a spot of reflected light may be specified only when the spot of the reflected light is located on a boundary line (a division line) of two light receiving surfaces included in the PD.

In the optical lever method, as displacement of a probe is increased, an amount of displacement of reflected light is increased. Therefore, when the displacement of the probe is increased, the spot of the reflected light projected on the light receiving element may overstep the boundary line and the entire spot may be projected on one of the light receiving surfaces. Therefore, in the general optical lever method, when the displacement of the probe is increased, the displacement of the probe may not be measured even though the spot of the reflected light is projected on the light receiving element.

Accordingly, the present disclosure provides a probe displacement measuring apparatus capable of measuring displacement of a probe larger than general displacement.

### SUMMARY OF THE INVENTION

A probe displacement measuring apparatus according to the present disclosure includes a cantilever probe, a light irradiation unit configured to irradiate the probe with light, a light receiving element configured to receive reflected light obtained by reflecting light emitted by the light irradiation unit on a surface of the probe as a spot, and a displacement obtaining unit configured to obtain displacement of the probe in accordance with a position of the spot on the light receiving element. The light receiving element has first and second light receiving surfaces divided by a straight division line. An angle defined by a displacement direction of the spot on the light receiving element and the division line is 0° or more and 90° or less.

Further features of the present disclosure will become apparent from the following description of exemplary embodiments with reference to the attached drawings.

### BRIEF DESCRIPTION OF THE DRAWINGS

FIG. 1A is a diagram illustrating a configuration of a probe displacement measuring apparatus according to a first embodiment, FIG. 1B is a diagram illustrating a light receiving element according to the first embodiment, and FIG. 1C is a diagram illustrating a light shielding unit according to the first embodiment.

FIG. 2A is a diagram illustrating light projected on the light receiving element in a case where the light shielding unit is not disposed according to the first embodiment, FIG. 2B is a diagram illustrating the light shielding unit according to the first embodiment, FIG. 2C is a diagram illustrating light projected on the light receiving element in a case where the light shielding unit is disposed according to the first embodiment, FIG. 2D is a diagram illustrating light projected on the light receiving element in a case where the light shielding unit is disposed according to the first embodiment, and FIG. 2E is a diagram illustrating a modification of the light receiving element of the first embodiment.

FIG. 3A is a diagram illustrating a configuration of a probe displacement measuring apparatus employing a general optical lever method, FIG. 3B is a diagram illustrating light projected on a light receiving element included in the probe displacement measuring apparatus employing the general optical lever method, and FIG. 3C is a diagram illustrating light projected on the light receiving element included in the probe displacement measuring apparatus employing the general optical lever method.

FIG. 4A is a diagram illustrating a configuration of a probe displacement measuring apparatus according to a second embodiment, FIG. 4B is a diagram illustrating a light receiving element according to the second embodiment, and FIG. 4C is a diagram illustrating a light shielding unit according to the second embodiment.

FIG. 5A is a diagram illustrating light projected on the light receiving element in a case where the light shielding unit is not disposed according to the second embodiment, FIG. 5B is a diagram illustrating the light shielding unit according to the second embodiment, FIG. 5C is a diagram illustrating light projected on the light receiving element in a case where the light shielding unit is disposed according to the second embodiment, FIG. 5D is a diagram illustrating light projected on the light receiving element in a case where the light shielding unit is disposed according to the second embodiment, and FIG. 5E is a diagram illustrating a modification of the light receiving element of the second embodiment.

FIG. 6 is a diagram illustrating a configuration of a probe displacement measuring apparatus according to a third embodiment.

FIG. 7A includes graphs illustrating results of measurement of an oscillation condition of a probe according to a first example, and FIG. 7B is a graph illustrating a result of simulation of the oscillating condition of the probe according to the first example.

FIG. 8A is a diagram schematically illustrating a sample according to a second example, FIG. 8B is a graph illustrating a result of mass spectrometry according to the second example, FIG. 8C is a graph illustrating a result of the mass spectrometry according to the second example, FIG. 8D is a 2D distribution image of signal intensity of pentavalent ions according to the second example, and FIG. 8E is an image illustrating structure information of the sample according to the second example.

### DESCRIPTION OF THE EMBODIMENTS

Embodiments of the present disclosure will be described in detail hereinafter with reference to the accompanying drawings. However, the present disclosure is not limited to the embodiments described below. In the present disclosure, changes and modifications of the embodiments described below are also included in the range of the present disclosure without departing from the scope of the disclosure on the basis of knowledges of those skilled in the art.

### First Embodiment

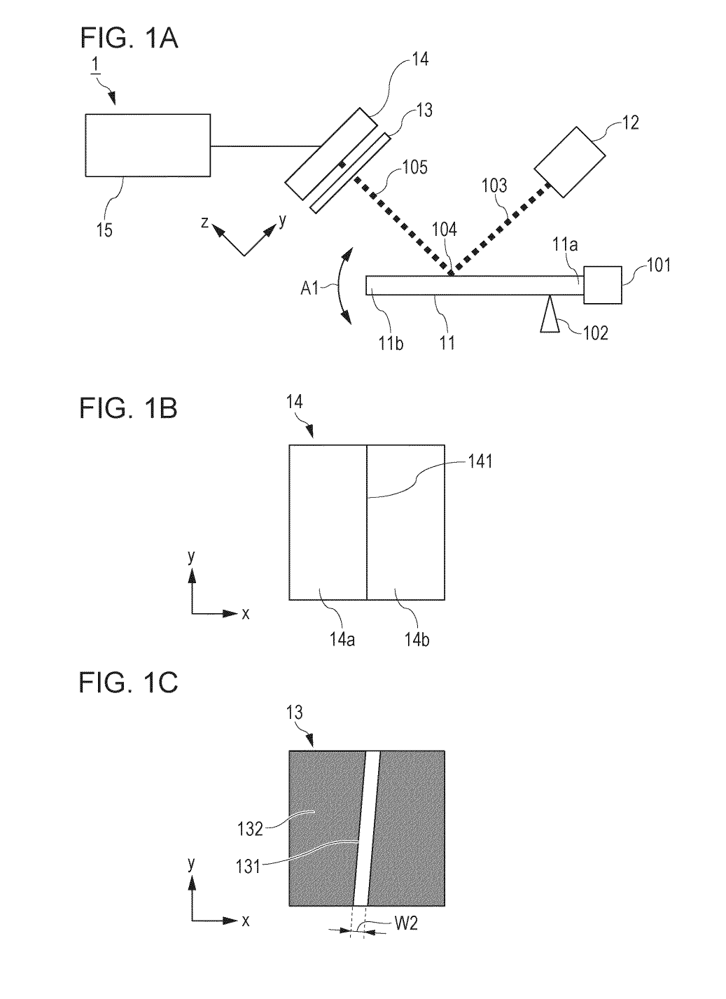

A configuration of a probe displacement measuring apparatus 1 (hereinafter referred to as an “apparatus 1”) according to a first embodiment will be described with reference to FIGS. 1A to 1C. FIGS. 1A to 1C are diagrams schematically illustrating the configuration of the apparatus 1 according to this embodiment.

The apparatus 1 of this embodiment includes a probe 11, a light source 12, a light shielding plate 13, a light receiving element 14 (hereinafter referred to as an “element 14”), and a calculation unit 15.

The probe 11 is a cantilever bar, a cantilever plate, or the like. Specifically, an end (a fixed end 11a) of the probe 11 is fixed to a body of the apparatus 1. The other end (a free end 11b) of the probe 11 may be displaced in a direction indicated by an arrow mark A1. That is, the free end 11b of the probe 11 is displaced in a yz plane in FIG. 1A. In this specification, the displacement of the free end 11b of the probe 11 is simply referred to as “displacement of the probe 11” where appropriate. The apparatus 1 measures the displacement of the probe 11 in the yz plane.

A shape of the probe 11 is not particularly limited, and the probe 11 may have a bar shape or a plate shape, for example. If the probe 11 has a bar shape, a prismatic shape or a cylindrical shape may be employed. In this case, the probe 11 may be solid or hollow. Specifically, the probe 11 may be a cylindrical hollow (a hollow round rod). Since the probe 11 has a cylinder hollow shape, fluid, such as liquid or gas, may be supplied to the free end 11b of the probe 11 through an inside of the probe 11.

Furthermore, material of the probe 11 is not particularly limited and inorganic material, such as resin, glass, metal, ceramic, or silicon, or the like may be used. However, material which easily reflects irradiation light 103 emitted from the light source 12 described below is preferably used at least for an irradiation portion 104 which is a portion of a surface of the probe 11. By this, an amount of reflected light 105 generated by the irradiation portion 104 may be increased. Note that a mirror or the like may be attached to the irradiation portion 104. Alternatively, the surface of the probe 11 may be coated by material having high reflectivity.

A unit which displaces the probe 11 is not particularly limited. As illustrated in FIG. 1A, for example, the probe 11 may be displaced by bringing an oscillator 102 into contact with the probe 11. In this way, an external force generated by the oscillator 102 is transmitted to the probe 11 so that the free end 11b of the probe 11 is oscillated. Alternatively, a supporting unit 101 which is used to fix the probe 11 on the body of the apparatus 1 may incorporate the oscillator 102 which oscillates the probe 11.

Furthermore, the probe 11 may be displaced by moving the free end 11b of the probe 11 close to a sample, not illustrated. If the free end 11b of the probe 11 is moved close to the sample not illustrated, the probe 11 is displaced due to interaction (such as atomic force, repulsive force, attractive force, viscosity, and electromagnetic force) acting between the free end 11b and a surface of the sample. The free end 11b of the probe 11 which is oscillated by the oscillator 102 as described above may be moved close to the sample so that the probe 11 is further displaced.

Note that, although the probe 11 is displaced in the direction indicated by the arrow mark A1 in this embodiment, the present invention is not limited to this. The free end 11b of the probe 11 may be displaced in an x direction in addition to the displacement in the yz plane in FIG. 1A. Specifically, the probe 11 may be displaced such that the displacement at least includes displacement in the yz plane measured by the apparatus 1. Furthermore, if the free end 11b of the probe 11 is oscillated by the oscillator 102, the free end 11b may be continuously oscillated or intermittently oscillated. Furthermore, the free end 11b may be oscillated in fixed amplitude or oscillated while amplitude is changed.

The light source 12 irradiates the surface (the irradiation portion 104) of the probe 11 with the irradiation light 103. That is, the light source 12 is a light irradiation unit which irradiates the probe 11 with light. The irradiation light 103 emitted on the surface of the probe 11 is reflected by the surface of the probe 11. By this, the reflected light 105 is generated.

A type of the light source 12 is not particularly limited and various light sources, such as a lamp light source and a laser light source, may be used. Among such light sources, a laser light source capable of emitting coherent light is preferably used since large light intensity of the reflected light 105 is obtained.

The apparatus 1 may include a condenser lens, not illustrated, as the light irradiation unit on an optical path of the irradiation light 103 in addition to the light source 12. By using the condenser lens, the irradiation light 103 emitted from the light source 12 is converged so that light intensity is increased before the irradiation light 103 reaches the surface of the probe 11.

A position of the irradiation portion 104 is not particularly limited as long as the irradiation portion 104 is located between the fixed end 11a and the free end 11b of the probe 11. However, if the position of the irradiation portion 104 is extremely close to the fixed end 11a, displacement of the probe 11 is difficult to be reflected in a light emitting direction, and therefore, the irradiation portion 104 is preferably positioned with an appropriate distance from the fixed end 11a. Furthermore, if the position of the irradiation portion 104 is extremely close to the free end 11b, a light emitting angle of the reflected light 105 is considerably changed as the probe 11 is displaced, and therefore, the irradiation portion 104 is preferably positioned with an appropriate distance from the free end 11b.

According to the apparatus 1 of this embodiment, displacement of the irradiation portion 104 may be measured. A distance from the fixed end 11a to the irradiation portion 104 is smaller than a distance from the fixed end 11a to the free end 11b. Therefore, a displacement amount of the free end 11b is larger than that of the irradiation portion 104. Displacement of the free end 11b may be measured by multiplying a displacement amount of the irradiation portion 104 by a value obtained by dividing the distance from the fixed end 11a to the free end 11b by the distance from the fixed end 11a to the irradiation portion 104.

Note that the irradiation light 103 may be emitted to a region which is larger than a width of the probe 11 (a width along the direction which is vertical to a line connecting the fixed end 11a and the free end 11b) when viewed from the light source 12, the irradiation light 103 is preferably emitted as a fine spot on the surface of the probe 11. By this, influence of reflected light which is emitted from portions other than the surface of the probe 11 may be suppressed.

A shape of a spot of the reflected light 105 depends on a shape of a spot of the irradiation light 103 and a surface profile of the probe 11. In a case where the irradiation portion 104 in the surface of the probe 11 is a flat plane, for example, the spot shape of the reflected light 105 is substantially the same as that of the irradiation light 103. Specifically, if the spot shape of the irradiation light 103 is a circular shape, the spot shape of the reflected light 105 is also substantially a circular shape. Alternatively, in a case where the irradiation portion 104 in the surface of the probe 11 is a curved plane, such as a case where a shape of the probe 11 is a cylinder solid shape or a cylinder hollow shape, the spot shape of the reflected light 105 more widely spreads in a transverse direction of the probe 11 when compared with the spot shape of the irradiation light 103.

The element 14 receives the reflected light 105 emitted from the surface of the probe 11. When receiving the reflected light 105, the element 14 outputs an electric signal corresponding to light intensity of the received reflected light 105. Specifically, the element 14 is a light detection unit which detects light.

The element 14 of this embodiment is a two-segment light receiving element including two light receiving surfaces which are adjacent to each other and which are divided by a straight division line 141. As illustrated in FIG. 1B, the two light receiving surfaces (first and second light receiving surfaces 14a and 14b) included in the element 14 are adjacent to each other through the division line 141. The element 14 of this embodiment includes the division line 141 in the yz plane. The first and second light receiving surfaces 14a and 14b included in the element 14 receive the reflected light 105 and output currents having current values proportional to light intensities of the reflected light 105 received by the first and second light receiving surfaces 14a and 14b.

A configuration of the element 14 is not particularly limited as long as the element 14 is a light receiving element at least including two light receiving surfaces which are adjacent to each other. As the element 14, a position-sensitive photoelectric conversion element (an image sensor) divided into pixels, such as a two-segment photodiode (PD), a four-segment photodiode (PD), a position sensitive detector (PSD), or a CCD may be used. Among these light receiving elements, the element 14 is preferably a two-segment photodiode in terms of a cost and facilitation of signal processing.

The calculation unit 15 obtains a position of the spot of the reflected light 105 emitted to the element 14 in accordance with the current values of the first and second light receiving surfaces 14a and 14b of the element 14. The position of the reflected light 105 on the element 14 is displaced depending on the displacement of the probe 11, and therefore, the displacement of the probe 11 may be measured by obtaining the position of the spot of the reflected light 105 on the element 14. That is, the calculation unit 15 is a displacement obtaining unit.

The calculation unit 15 converts current signals supplied from the first and second light receiving surfaces 14a and 14b into voltage signals. The calculation unit 15 further calculates a difference between the voltage values of the voltage signals. The calculation unit 15 measures a displacement amount of the probe 11 by measuring amplitude of a signal corresponding to the difference between the voltage values of the voltage signals.

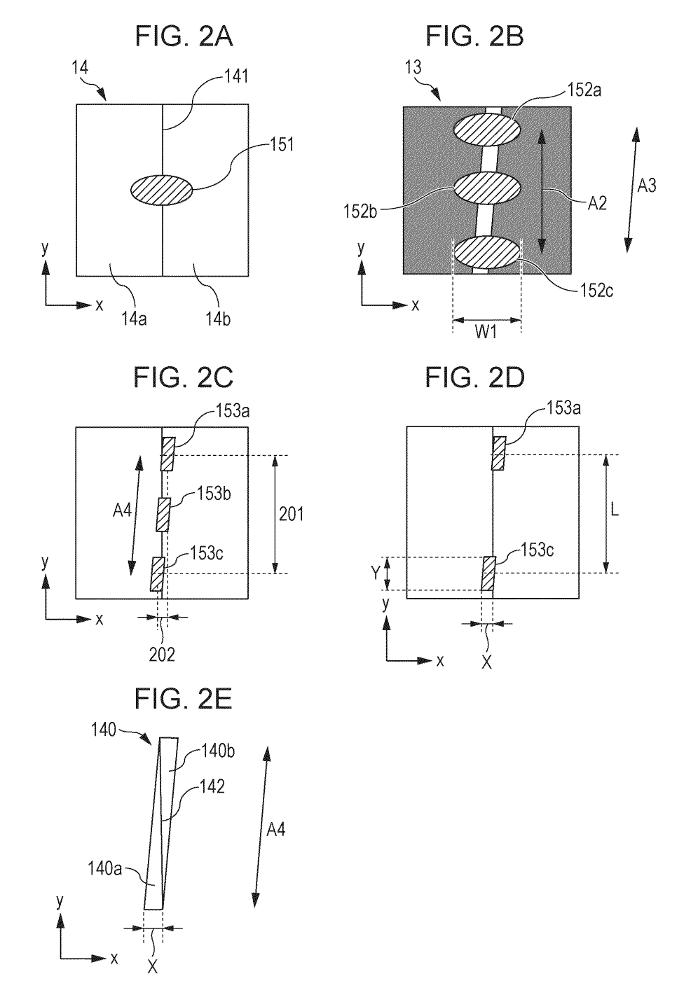

Furthermore, the apparatus 1 of this embodiment includes the light shielding plate 13 on an optical path of the reflected light 105. Hereinafter, the light shielding plate 13 will be described in detail with reference to FIGS. 1A to 1C and FIGS. 2A to 2E. FIGS. 2A to 2E are diagrams schematically illustrating the light shielding plate 13, the element 14, and the spot the reflected light 105 according to this embodiment. Here, a case where the irradiation portion 104 has a flat shape and a spot of the irradiation light 103 has an oval shape having a long axis in a depth direction of the sheet of FIGS. 1A to 1C (an x direction) will be described. Note that the shape of the spot of the irradiation light 103 and the shape of the irradiation portion 104 are not limited to these.

In this embodiment, the element 14 is disposed such that the division line 141 is positioned in the yz plane of FIG. 1A which is the plane along the displacement of the probe 11 measured by the apparatus 1. Here, the element 14 is preferably disposed such that a center axis of the probe 11 and the division line 141 are positioned in the same plane. By this, arrangement of the probe 11 and the element 14 is easily controlled.

FIG. 2A is a diagram illustrating a case where the light shielding plate 13 is not disposed on the optical path of the reflected light 105. As described above, in the case where the irradiation portion 104 is a flat plane, the shape of the spot of the reflected light 105 is substantially the same as that of the irradiation light 103. Therefore, as illustrated in FIG. 2A, the reflected light 105 is projected as an oval spot 151 on the element 14. When the probe 11 is displaced in the yz plane, the spot 151 of the reflected light 105 is displaced in a y direction on the division line 141.

FIG. 1C and FIG. 2B are diagrams schematically illustrating the light shielding plate 13 according to this embodiment. As illustrated in FIG. 1C, the light shielding plate 13 of this embodiment includes a transmissive portion 131 having a slit shape and a light shielding portion 132. The transmissive portion 131 allows light to be transmitted and the light shielding portion 132 blocks light. When the light shielding plate 13 is disposed on the optical path between the irradiation portion 104 on the optical path of the reflected light 105 and the element 14, the reflected light 105 is projected on the light shielding plate 13 as a spot 152 (FIG. 2B). The light shielding plate 13 blocks light projected on the light shielding portion 132 in the spot 152 projected on the light shielding plate 13 and selectively allows light projected on the transmissive portion 131 to pass.

Material of the light shielding portion 132 of the light shielding plate 13 is not particularly limited as long as the light shielding portion 132 may block the reflected light 105. Furthermore, the light shielding plate 13 including the transmissive portion 131 may be easily fabricated by making a slit in the light shielding portion 132 having a plate shape. Here, a slit width W2 of the transmissive portion 131 is preferably smaller than a long diameter W1 of the spot 152. By this, a portion of the spot 152 is extracted and light projected on the transmissive portion 131 may be selectively transmitted.

When the probe 11 is displaced in the direction indicated by the arrow mark A1 of FIG. 1A, a position of the spot 152 on the light shielding plate 13 is also displaced in a direction indicated by an arrow mark A2 of FIG. 2B. Accordingly, when the free end 11b of the probe 11 is oscillated, the spot 152 is oscillated a region between a spot 152a and a spot 152c. Note that, a spot 152b is obtained in a case where the probe 11 is not displaced (a case where the free end 11b is located in a center of oscillation). The spots 152a and 152c are obtained in a case where the free end 11b of the probe 11 is located in the highest position and a case where the free end 11b of the probe 11 is located in the lowest position, respectively.

In this embodiment, the transmissive portion 131 of a slit shape included in the light shielding plate 13 is disposed such that a direction of a length of the slit of the transmissive portion 131 (indicated by an arrow mark A3) is not in parallel to and not perpendicular with the direction of the displacement of the spot 152 (indicated by the arrow mark A2). That is, an angle θ1 defined by the direction of the length of the slit of the transmissive portion 131 (indicated by the arrow mark A3) and the direction of the displacement of the spot 152 (indicated by the arrow mark A2) satisfies the following relationship.

0°<θ1<90° Expression (1)

FIG. 2C is a diagram illustrating light projected on the element 14 in a case where the light shielding plate 13 is disposed on the optical path of the reflected light 105. As described above, in the spot 152 projected on the light shielding plate 13, light which is projected on the transmissive portion 131 passes the light shielding plate 13. The light which passes the light shielding plate 13 is projected as a spot 153 on the element 14. Note that, a spot 153b is obtained in a case where the probe 11 is not displaced (a case where the free end 11b is located in a center of oscillation). Spots 153a and 153c are obtained in a case where the free end 11b of the probe 11 is located in the highest position and a case where the free end 11b of the probe 11 is located in the lowest position, respectively.

A position of the spot 153 on the element 14 is displaced in a direction (indicated by an arrow mark A4) in parallel to the direction of the length of the slit of the transmissive portion 131 (indicated by the arrow mark A3) in accordance with the displacement of the probe 11. Specifically, an angle defined by a direction of displacement of the spot 153 on the element 14 (indicated by the arrow mark A4) and the direction of the displacement of the spot 152 (indicated by the arrow mark A2) is also θ1. Furthermore, since the element 14 of this embodiment is disposed such that the division line 141 is located on the yz plane, an angle defined by the direction of the displacement of the spot 153 on the element 14 (denoted by the arrow mark A4) and the division line 141 is also θ1. Accordingly, these angles also satisfy Expression (1), that is, the angles are larger than 0° and smaller than 90°.

In this way, according to this embodiment, since the light shielding plate 13 including the transmissive portion 131 of the slit shape is disposed on the optical path of the reflected light 105, the direction of the displacement of the spot of the reflected light 105 on the element 14 may be changed from the direction indicated by the arrow mark A2 to the direction indicated by the arrow mark A3. By changing the direction of the displacement of the spot on the element 14, a displacement amount 201 in a vertical direction (the direction denoted by the arrow mark A2) of the spot may be compressed to a small displacement amount 202 in the x direction (a direction perpendicular to the arrow mark A2). Accordingly, even in a case where the element 14 capable of measuring only a limited displacement amount of the spot on the element 14, such as a two-segment photodiode, is used, a large displacement of the probe 11 may be measured. Note that the term “displacement amount” in this specification represents a distance between centers of gravities of spots on the element 14 obtained before and after the displacement.

Furthermore, a compression rate of the compression of the displacement amount described above is tan θ1 when the angle θ1 defined by the direction of the length of the slit of the transmissive portion 131 (indicated by the arrow mark A3) and the direction of the displacement of the spot 152 (indicated by the arrow mark A2) are used. Specifically, since the light shielding plate 13 including the slit transmissive portion 131 which is inclined by θ1 relative to the displacement direction 201 of the spot 152 is used, the displacement amount of the spot may be compressed tan θ1 times.

The calculation unit 15 of this embodiment calculates and obtains a difference ΔV between the voltage values of the electric signals supplied from the first and second light receiving surfaces 14a and 14b (Expression (2)).

ΔV=Vₐ−V_{b} Expression (2)

Here, “Vₐ” and “V_{b}” denote the voltage values of the electric signals which are proportional to the light intensities of the reflected light 105 emitted to the first and second light receiving surfaces 14a and 14b, respectively. A value ΔV′ which is represented by Expression (3) may be obtained instead of Expression (2).

ΔV′=ΔV/(Vₐ+V_{b})=(Vₐ−V_{b})/(Vₐ+V_{b}) Expression (3)

Note that, since the calculation unit 15 performs the calculation represented by Expression (2) or Expression (3), the current signals supplied from the first and second light receiving surfaces 14a and 14b may be converted into voltage signals using a current-voltage conversion circuit before the calculation. The calculation is preferably performed on the signals using an adder circuit or a differential amplification circuit.

The value represented by Expression (2) or Expression (3) has one-to-one correspondence with the displacement of the spot 153 on the element 14 in a direction perpendicular to the division line 141 (the x direction). Therefore, the calculation unit 15 may obtain the displacement of the spot 153 on the element 14 in the x direction by calculating Expression (2) or Expression (3).

In a case where the spot 153 is emitted on the first and second light receiving surfaces 14a and 14b in equal areas, a result of the calculation of Expression (2) or Expression (3) is zero. On the other hand, in a case where the spot 153 is emitted on the first and second light receiving surfaces 14a and 14b in different areas, a result of the calculation of Expression (2) or Expression (3) is a positive value or a negative value depending on the areas of the spot 153 on the first and second light receiving surfaces 14a and 14b.

In this embodiment, before the apparatus 1 is used, the position of the element 14 is controlled such that the spot 153 is emitted to the first and second light receiving surfaces 14a and 14b in the equal areas in a state in which the displacement of the probe 11 is zero. Specifically, before the apparatus 1 is used, a result of the calculation represented by Expression (2) or Expression (3) is zero in the state in which the displacement of the probe 11 is zero. By this, when the probe 11 is displaced, the spot 153 is displaced in the x direction on the element 14 and the areas of the spot 153 on the first and second light receiving surfaces 14a and 14b are changed. Consequently, a position of the spot 153 on the element 14 in the x direction may be obtained by calculating Expression (2) or Expression (3) using the calculation unit 15. Furthermore, the displacement of the probe 11 in the yz plane corresponding to the obtained position of the spot 153 on the element 14 in the x direction may also be obtained.

Note that when the free end 11b of the probe 11 is oscillated in the yz plane, the spot 153 on the element 14 is also oscillated in the x direction. Then the voltage signal obtained as a result of the calculation in Expression (2) or Expression (3) is also oscillated in a frequency of the oscillation of the probe 11 and the spot 153. Furthermore, signal intensities of the voltage signals are proportional to the light intensity of the spot 153 and the areas of the spot 153 on the first and second light receiving surfaces 14a and 14b. Moreover, the signal intensities of the voltage signals are proportional to amplitude of the oscillation of the probe 11. Therefore, the amplitude of the oscillation of the probe 11 in the yz plane may be measured by measuring the displacement of the spot 153 on the element 14 in the x direction.

As described above, the position of the spot 153 on the element 14 in the x direction is changed in accordance with the displacement of the probe 11 in the yz plane. It is preferable that at least a portion of the spot 153 of this embodiment is included in the first light receiving surface 14a and at least the other portion is included in the second light receiving surface 14b at all time even if the probe 11 is displaced. Specifically, the spot 153 is preferably located on the division line 141 at all time. By this, the displacement of the spot 153 on the element 14 may be uniquely determined in accordance with the result of the calculation in Expression (2) or Expression (3).

As illustrated in FIG. 2D, it is assumed that a width of the spot 153 is denoted by “X” and a height of the spot 153 is denoted by “Y”. It is further assumed that displacement between the spot 153c obtained in the case where the spot 153 is located in the lowest position on the element 14 and the spot 153a obtained in the case where the spot 153 is located in the highest position on the element 14 is denoted by “L”. Specifically, amplitude of the displacement of the spot 153 corresponding to amplitude of the displacement of the probe 11 is denoted by “L”. Here, since the spot 153 is located on the division line 141 at all time, Expression (4) below is preferably satisfied.

0°<θ1<tan⁻¹(X/(L−Y)) Expression (4)

Note that, in a case where a distance between the element 14 and the light shielding plate 13 is small, the width X of the spot 153 on the element 14 may be seen to be equal to the width W2 of the slit of the transmissive portion 131 included in the light shielding plate 13.

Since the light shielding plate 13 is used in this embodiment, the angle defined by the direction of the displacement of the spot 153 on the element 14 (indicated by the arrow mark A4) and the division line 141 of the element (the y direction) is set to be larger than 0° and smaller than 90°. By this, large displacement of the probe 11 on the yz plane which is difficult to be measured by probe displacement measuring apparatuses employing the general optical lever method may be measured.

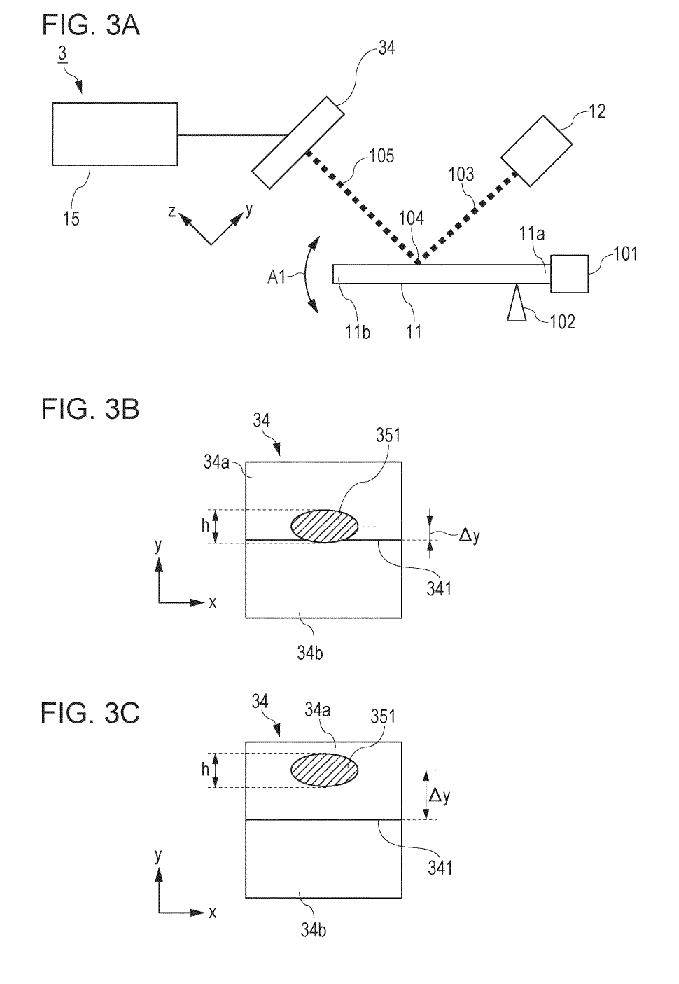

A probe displacement measuring apparatus 3 (hereinafter referred to as an “apparatus 3”) in the related art will be described with reference to FIGS. 3A to 3C. The apparatus 3 is a probe displacement measuring apparatus employing a light receiving element 34 (hereinafter referred to as an “element 34”) instead of the element 14 and the light shielding plate 13 in the apparatus 1 according to the first embodiment illustrated in FIGS. 1A to 1C.

As with the element 14, the element 34 is a two-segment light receiving element. Specifically, the element 34 includes two light receiving surfaces (first and second light receiving surfaces 34a and 34b) divided by a straight division line 341. However, as illustrated in FIGS. 3A and 3B, the element 34 is disposed such that the division line 341 is perpendicular to a yz plane. In other words, the element 34 is in a state in which the element 14 of the first embodiment is rotated by 90° in the xy plane.

FIGS. 3B and 3C are diagrams schematically illustrating a state in which reflected light 105 is projected on the element 34 as a spot 351. The spot 351 is displaced, as with the first embodiment, in a y direction on the element 34 in accordance with displacement of a probe 11. In the related art, the displacement of the spot 351 on the element 34 in the y direction is obtained using Expression (2) or Expression (3).

As described above, in order to uniquely determine the displacement (a position) of the spot 351 on the element 34 using Expression (2) or Expression (3), the spot 351 is required to be located on the division line 341 at all time. Therefore, a measurement available condition of the apparatus 3 employing the general optical lever method illustrated in FIGS. 3A to 3C is represented by the following expression.

Δy≦h/2 Expression (5)

It is assumed here that a length of the spot 351 in the y direction is denoted by “h” and a displacement amount of the spot 351 from the division line 341 is denoted by “Δy”.

On the other hand, in a case where the displacement of the probe 11 in the yz plane is increased, the displacement amount of the spot 351 on the element 34 is also increased as illustrated in FIG. 3C. Here, as illustrated in FIG. 3C, the spot 351 is not located on the division line 341 in some cases. That is, Expression (5) is not satisfied. In this case, the apparatus 3 may not reliably measure a position of the spot 351 on the element 34, and therefore, the displacement of the probe 11 in the yz plane may not be reliably measured. As described above, it is difficult for the apparatus 3 employing the general optical lever method to measure large displacement of the probe 11.

Note that a displacement amount of the spot 351 on the element 34 may be reduced by disposing the element 34 sufficiently close to an irradiation portion 104. In this way, even in a case where the displacement of the probe 11 is large, the displacement of the probe 11 may be theoretically measured. However, if the element 34 is positioned close to the irradiation portion 104, interference of the element 34 with the other components and the other measuring devices disposed near the probe 11 occurs or the displacement of the probe 11 is disturbed in practice. Therefore, it is preferable that the element 34 and the probe 11 are disposed with an appropriate distance therebetween.

On the other hand, according to the apparatus 1 of the first embodiment, even in a case where the displacement of the probe 11 is large, the element 14 may be disposed in a position where the element 14 does not interfere with the other components disposed near the probe 11. Accordingly, a probe displacement measuring apparatus capable of measuring large displacement of the probe 11 while a degree of freedom of design is maintained may be provided.

Although the case where the light shielding plate 13 including the slit transmissive portion 131 is used is described in the first embodiment, the light shielding plate 13 may not be used. In this case, a two-segment light receiving element 140 having an appearance of a parallelogram shape may be employed as illustrated in FIG. 2E.

As with the element 14, the light receiving element 140 has two light receiving surfaces 140a and 140b divided by a division line 142. The appearance of the light receiving element 140 illustrated in FIG. 2E is the same as that of the transmissive portion 131 of the first embodiment. The two light receiving surfaces 140a and 140b of the light receiving element 140 are located adjacent to each other through the division line 142. Since the light receiving element 140 is disposed such that the division line 142 is included in the yz plane in the apparatus 1, an effect the same as that of the first embodiment may be obtained.

### Second Embodiment

Next, a probe displacement measuring apparatus 4 (hereinafter referred to as an “apparatus 4”) according to a second embodiment of the present invention will be described. Hereinafter, descriptions of portions the same as those of the first embodiment are omitted and unique configurations of the apparatus 4 of the second embodiment will be described.

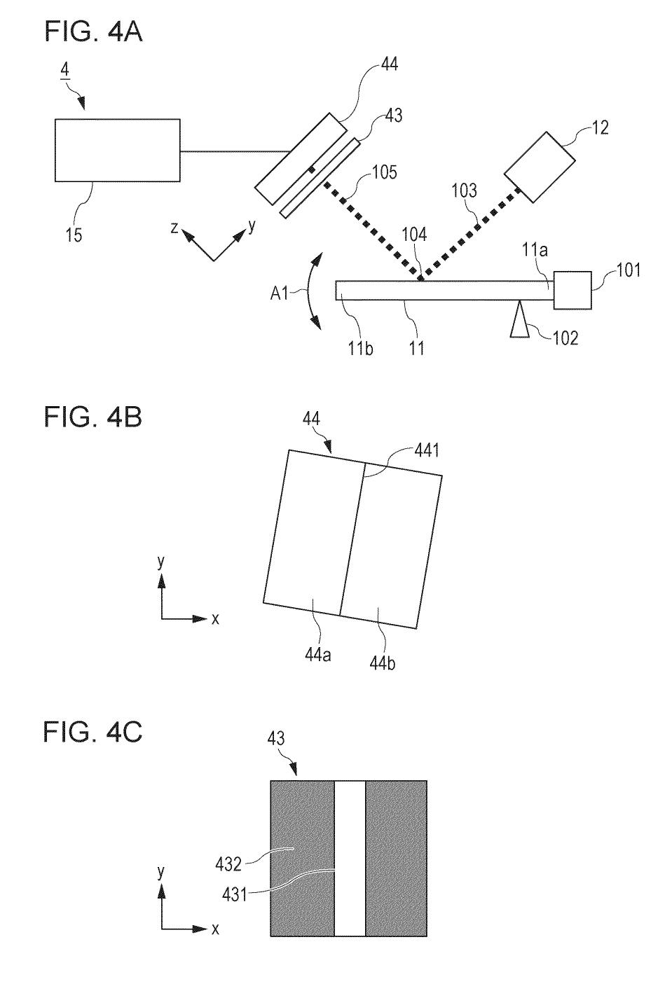

A configuration of the apparatus 4 will now be described with reference to FIGS. 4A to 4C. FIGS. 4A to 4C are diagrams schematically illustrating the configuration of the apparatus 4 of this embodiment. The apparatus 4 of this embodiment includes a light receiving element 44 (hereinafter referred to as an “element 44”) and a light shielding plate 43 instead of the element 14 and the light shielding plate 13, respectively, of the apparatus 1 of the first embodiment. The other configurations are the same as those of the first embodiment.

As illustrated in FIG. 4B, as with the element 14, the element 44 includes two light receiving surfaces (first and second light receiving surfaces 44a and 44b) divided by a straight division line 441. Although the element 14 is disposed such that the division line 141 is located on the yz plane in the first embodiment, the element 44 is disposed such that the division line 441 intersects with a yz plane in this embodiment. Specifically, the element 44 is disposed such that an angle defined by the division line 441 and a y axis is larger than 0° and smaller than 90°. That is, the element 44 is obtained by rotating the element 14 in an arbitrary direction by an angle larger than 0° and smaller than 90° in an xy plane.

As with the light shielding plate 13, the light shielding plate 43 includes a slit transmissive portion 431 and a light shielding portion 432 as illustrated in FIG. 4C. Although the transmissive portion 131 is disposed such that the angle defined by the direction of the length of the slit and the yz plane is larger than 0° and smaller than 90° in the first embodiment, the transmissive portion 431 is disposed such that a direction of a length of the slit and the yz plane are parallel to each other in this embodiment. It is preferable here that the light shielding plate 43 is disposed such that a center line which is parallel to the direction of the length of the slit of the transmissive portion 431 and a center axis of the probe 11 are positioned in the same plane. In this way, arrangement of the light shielding plate 43 and the probe 11 may be easily controlled.

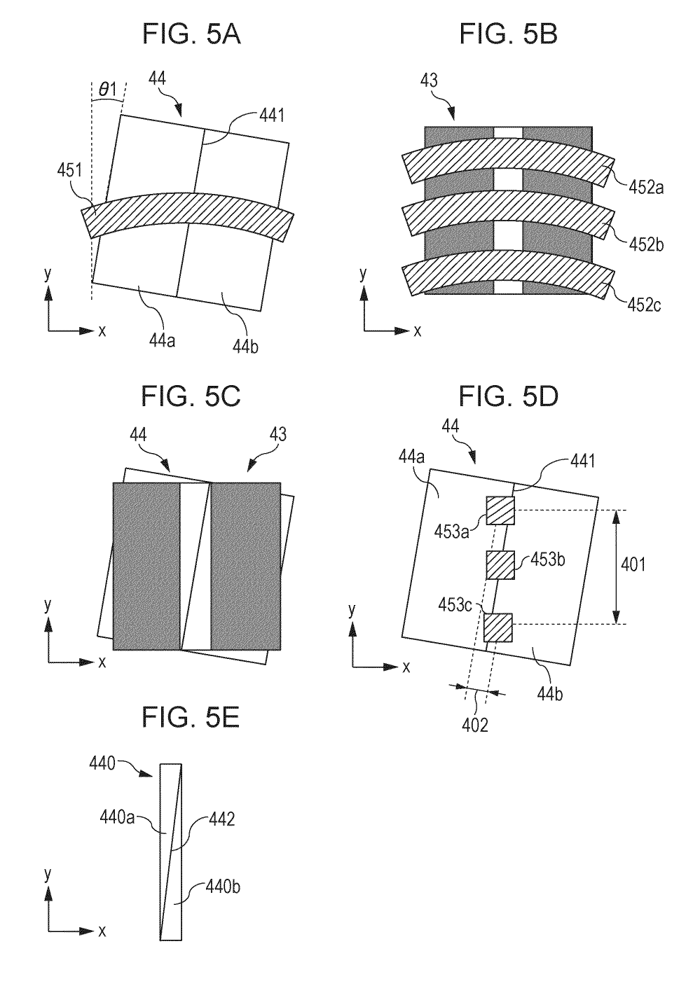

Next, behavior of the reflected light 105 on the element 44 of this embodiment will be described with reference to FIGS. 5A to 5E. Here, a case where an irradiation portion 104 has a curved shape and a spot of irradiation light 103 has an oval shape having a long axis in a depth direction of the sheet of FIG. 1 (an x direction) will be described. Note that the shape of the spot of the irradiation light 103 and the shape of the irradiation portion 104 are not limited to these.

FIG. 5A is a diagram illustrating a case where the light shielding plate 43 is not disposed on an optical path of reflected light 105. In the case where the irradiation portion 104 is a curved plane, a spot of the reflected light 105 has a parabolic band shape as illustrated in FIG. 5A. If the probe 11 is displaced in the yz plane, a spot 451 of the reflected light 105 projected on the element 44 is displaced in a y direction.

FIG. 5B is a diagram schematically illustrating the light shielding plate 43 of this embodiment. When the light shielding plate 43 is disposed between the irradiation portion 104 on the optical path of the reflected light 105 and the element 44 as illustrated in FIG. 5B, the reflected light 105 is projected on the light shielding plate 43 as a spot 452 (FIG. 5B). In the spot 452 projected on the light shielding plate 43, the light shielding plate 43 blocks light projected on the light shielding portion 432 and selectively allows light projected on a transmissive portion 431 to pass.

When the probe 11 is displaced in the direction indicated by an arrow mark A1 of FIG. 4A, a position of the spot 452 on the element plate 44 is also displaced in the y direction. Accordingly, when a free end 11b of the probe 11 is oscillated, the spot 452 is oscillated in a region between a spot 452a and a spot 452c. Note that, a spot 452b is obtained in a case where the probe 11 is not displaced (a case where the free end 11b is located in a center of oscillation). The spots 452a and 452c are obtained in a case where the free end 11b of the probe 11 is located in the highest position and a case where the free end 11b of the probe 11 is located in the lowest position, respectively.

In this embodiment, the element 44 and the light shielding plate 43 are disposed in a state of FIG. 5C viewed from a direction in which the reflected light 105 is emitted. With this arrangement, only light projected on the transmissive portion 431 of the light shielding plate 43 is transmitted through the light shielding plate 43 and projected on the element 44 as the spot 453 (FIG. 5D).

In this case, it is preferable that a position of the light shielding plate 43 in the apparatus 4 is controlled such that a top portion of the parabolic spot 451 is positioned at a center of a slit width of the transmissive portion 431. Accordingly, the spot 453 has a bilaterally symmetric shape, and the position of the spot 453 on the element 44 is easily obtained. Furthermore, it is preferable that the slit width of the transmissive portion 431 is sufficiently large so that the spot 453 is located on the division line 441 on the element 44 irrespective of a position of the spot 451 on the light shielding plate 43.

As with the first embodiment, the position of the spot 453 on the element 44 may be obtained in accordance with a result of calculation of Expression (2) or Expression (3) in this embodiment. Displacement of the probe 11 may be measured in accordance with a result of the obtainment. Here, as with the first embodiment, since the light shielding plate 43 is used, a displacement amount 401 in a vertical direction of the spot 453 of the reflected light 105 on the element 44 may be compressed so that a smaller displacement amount 402 is obtained in this embodiment. Accordingly, even in a case where the element 44 capable of measuring only a limited displacement amount of the spot 453 on the element 44, such as a two-segment photodiode, is used, large displacement of the probe 11 may be measured.

As described above, according to this embodiment, large displacement of the probe 11 may be measured using the element 44 which is inclined relative to the yz plane and the light shielding plate 43.

Although the case where the light shielding plate 43 including the slit transmissive portion 431 is used is described in this embodiment, the light shielding plate 43 may not be used. In this case, a two-segment light receiving element 440 illustrated in FIG. 5E may be employed.

As with the element 44, the light receiving element 440 has two light receiving surfaces 440a and 440b divided by a division line 442. An appearance of the light receiving element 440 illustrated in FIG. 5E is the same as that of the transmissive portion 431 of the second embodiment. The two light receiving surfaces 440a and 440b of the light receiving element 440 are disposed adjacent to each other through the division line 442. Since the light receiving element 440 is disposed such that a longitudinal direction of the light receiving element 440 is parallel to a y axis, an effect the same as that of the second embodiment may be obtained.

Furthermore, in the case where the irradiation portion 104 of the probe 11 is a curved plane as described in this embodiment, a spot of the reflected light 105 has a shape which is more complicated than an oval shape. Therefore, detection of displacement using the general optical lever method is difficult. However, a position of a spot of the reflected light 105 on a light receiving element may be obtained by extracting the reflected light 105 using a light shielding plate having a slit transmissive portion as described in this embodiment and the first embodiment.

### Third Embodiment

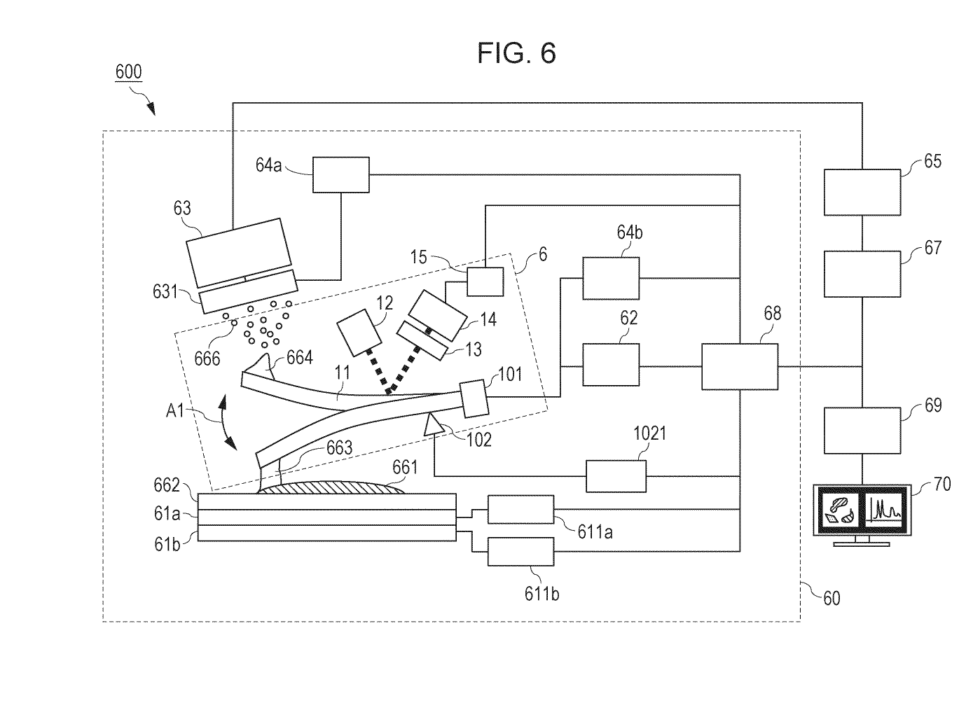

Next, a configuration of a mass spectrometry apparatus including an ionization apparatus having a probe displacement measuring apparatus according to the present invention will be described with reference to FIG. 6. FIG. 6 is a diagram illustrating a configuration of a mass spectrometry apparatus 600 according to a third embodiment.

An ionization apparatus 60 (hereinafter referred to as an “apparatus 60”) according to this embodiment includes a probe displacement measuring apparatus 6 (hereinafter referred to as an “apparatus 6”), a stage 61 which holds a sample 661, a liquid supplying unit 62, an ion intake unit 63, an electric field generation unit 64, and a control unit 68. A configuration of the apparatus 6 is the same as those of the apparatus 1 and the apparatus 4.

The ion intake unit 63 includes an ion extraction electrode 631 connected to a voltage applying device 64a included in the electric field generation unit 64. Furthermore, the ion intake unit 63 is connected to a mass spectrometry unit 65 and capable of transmitting ions obtained by the ion intake unit 63 to the mass spectrometry unit 65.

In the apparatus 60 of this embodiment, the sample 661 is mounted on the stage 61 through a substrate 662. The stage 61 is connected to a stage control unit 611. The stage 61 includes an XY stage 61a which moves the sample 661 in a horizontal direction (an XY direction) relative to the stage 61 and a Z stage 61b which moves the sample 661 in a vertical direction (a Z direction) relative to the stage 61. Furthermore, the stage control unit 611 includes an XY control unit 611a which controls a movement of the XY stage 61a and a Z control unit 611b which controls a movement of the Z stage 61b. The Z control unit 611b is capable of oscillating the Z stage 61b in the Z direction.

Specifically, the XY control unit 611a and the XY stage 61a are an XY scanning unit which relatively performs scanning on a probe 11 and a surface of the sample 661 in the XY direction. Furthermore, the Z control unit 611b and the Z stage 61b configure a Z scanning unit (a distance changing unit) which changes a distance between the probe 11 and the sample 661 in the Z direction. Although the units which relatively perform scanning on the sample 661 and the probe 11 by moving the sample 661 is used as the XY scanning unit and the Z scanning unit in this embodiment, the present invention is not limited to this. Specifically, the XY scanning unit and the Z scanning unit may be realized by units which move the probe 11 in the XY direction or the Z direction.

The probe 11 includes a flow path (not illustrated) in an inner portion or an external portion thereof. Liquid supplied from the liquid supplying unit 62 passes the flow path (not illustrated) of the probe 11 and is supplied to a portion in the vicinity of a free end 11b of the probe 11. Thereafter, when the free end 11b of the probe 11 moves close to the sample 661, the liquid is applied to a region of a portion of a surface of the sample 661. The liquid applied to the region of the portion of the surface of the sample 661 forms a liquid bridge 663 between the sample 661 and the free end 11b of the probe 11.

Note that the term “liquid bridge” in this embodiment represents a state in which liquid supplied from the probe 11 is attached to at least both of the probe 11 and the sample 661. The liquid bridge 663 is formed by surface tension and the like of the liquid. A substance included in the sample 661 dissolves in the liquid bridge 663. In this embodiment, the liquid bridge 663 is formed under an environment of atmospheric pressure. A volume of the liquid bridge 663 of this embodiment is small and specifically, is approximately 1×10⁻¹² mL. The liquid bridge 663 is disposed on a fine region on the surface of the sample 661, and an area of the liquid bridge 663 on the surface of the sample 661 is approximately 1×10⁻⁸ m².

As the liquid supplied from the liquid supplying unit 62, solvent capable of dissolving a substance to be analyzed included in the sample 661 is preferably used. Here, the solution obtained by dissolving the substance to be analyzed in the solvent in advance may be used as the liquid supplied from the liquid supplying unit 62. When the liquid bridge 663 is formed, a substance included in the surface of the liquid bridge 663 dissolves in the liquid forming the liquid bridge 663. Note that the liquid bridge 663 is not formed in a case where shortage of an amount of liquid supplied from the probe 11 occurs or a case where liquid is attached to a side of the free end 11b which is opposite to a side near the substrate 662.

Furthermore, the liquid supplied from the liquid supplying unit 62 is guided through a conductive flow path (not illustrated) to an internal flow path or an external flow path (not illustrated) of the probe 11. Here, a voltage applying unit 64b applies a voltage to the liquid through the conductive flow path (not illustrated). A type of the voltage applied to the liquid is not particularly limited, and a direct current voltage, an alternating current voltage, a pulse voltage, or zero volts may be applied.

As described above, in this embodiment, an electric field is formed between the free end 11b of the probe 11 to which the liquid is attached and the ion extraction electrode 631 described below by applying a voltage different from a voltage applied to the ion extraction electrode 631 described below to the liquid flowing the flow path of the probe 11. Note that a voltage applied by the voltage applying unit 64b may be zero volts as long as the electric field is formed. A difference between a potential of the liquid to which the voltage is applied and a potential of the ion extraction electrode 631 to which the voltage is applied is preferably 0.1 kV or more and 10 kV or less, and more preferably, 3 kV or more and 5 kV or less. When the potential difference is included in this range, ionization caused by generation of electrospray described below may be efficiently performed.

As the probe 11, a thin tube capable of supplying liquid of a microvolume is preferably used. Material of the thin tube is not particularly limited and an insulating body, a conductive body, or a semiconductor is used. As the probe 11, silica capillary or metal capillary, for example, may be suitably employed. Note that the conductive flow path (not illustrated) is at least a portion of an entire flow path which guides the liquid supplied from the liquid supplying unit 62 through the internal flow path or the external flow path of the probe 11 to the free end 11b of the probe 11, and a position of the conductive flow path is not particularly limited. For example, the entire conductive flow path or a portion of the conductive flow path may be included the internal flow path or the external flow path of the probe 11 or a tube which connects the probe 11 and the liquid supplying unit 62 to each other.

Although a configuration in which the liquid supplying unit 62 is connected to the probe 11 is illustrated in FIG. 6, the liquid supplying unit 62 and the probe 11 may be spatially separated from each other. The liquid supplying unit 62 disposed spatially separated from the probe 11 may eject liquid to the probe 11 by an inkjet method so that the liquid is attached to the probe 11.

The oscillator 102 is a unit for oscillating the probe 11. The oscillator 102 oscillates the free end 11b of the probe 11. Note that oscillation of the probe 11 in this specification means that the probe 11 is moved such that a position of the free end 11b of the probe 11 is spatially displaced. In particular, the oscillator 102 preferably causes the probe 11 to perform bending oscillation in a direction intersecting with a longitudinal direction of the probe 11 as illustrated in FIG. 6. A distance between the free end 11b of the probe 11 and the sample 661 is periodically changed due to the oscillation.

A type of the oscillator 102 is not particularly limited as long as the oscillator 102 causes oscillation having certain amplitude repeatability when a voltage is applied from a voltage applying device 1021. For example, a piezoelectric element or a vibration motor may be used as the oscillator 102. The piezoelectric element and the vibration motor are capable of providing oscillation of a high frequency and have high durability, and therefore, are suitable for the oscillator 102 of this embodiment.

A position of the oscillator 102 is not particularly limited as long as the oscillator 102 is capable of transmitting oscillation to the probe 11. It is not necessarily the case that the oscillator 102 is in contact with the probe 11 in a state in which the probe 11 is stopped. However, in this case, the oscillator 102 is required to be in contact with the probe 11 for transmission of oscillation in a certain cycle of oscillation of the probe 11. A plurality of oscillators 102 may face each other so as to sandwich the probe 11. With this configuration, oscillation may be stably applied to the probe 11.

In this embodiment, the oscillator 102 itself oscillates and transmits the oscillation so as to oscillate the probe 11 as a method for oscillating the probe 11 by the oscillator 102. However, the probe 11 may be formed of a piezoelectric element or the like and a voltage may be applied to the probe 11 so that the probe 11 is oscillated. Alternatively, the probe 11 may be oscillated by applying a magnetic field to the probe 11 by the oscillator 102.

When the oscillator 102 transmits the oscillation to the probe 11 in which the liquid bridge 663 is formed between the probe 11 and the sample 661, the probe 11 is oscillated while the liquid which forms the liquid bridge 663 is attached to the free end 11b of the probe 11. Specifically, a state in which the probe 11 and the sample 661 are connected to each other through the liquid and a state in which the probe 11 and the sample 661 are separated from each other may be separately generated when the probe 11 is oscillated.

In the state in which the probe 11 is separated from the sample 661 due to the oscillation, the liquid forming the liquid bridge 663 is positioned close to the ion intake unit 63 including the ion extraction electrode 631. Here, a voltage different from the voltage applied to the probe 11 by the voltage applying device 64a is applied to the ion extraction electrode 631. Specifically, an electric field is formed between the liquid attached to the free end 11b and the ion extraction electrode 631.

The liquid is moved to a side surface of the probe 11 near the ion intake unit 63 due to the electric field and forms a Taylor cone 664. Note that the Taylor cone 664 is formed on a continuous surface which forms the probe 11 in the longitudinal direction in FIG. 6. However, a position where the Taylor cone 664 is formed is affected by the electric field generated between the ion extraction electrode 631 and the liquid, wettability of the probe 11 relative to the liquid, and the like, and therefore, the Taylor cone 664 may be formed in a position including a surface other than this surface.

The electric field is increased in a tip of the Taylor cone 664, electrospray is generated from the liquid, and small charged droplets 666 are generated. The charged droplets 666 are splashed to the ion extraction electrode 631 by the electric field generated between the ion extraction electrode 631 and the liquid. By appropriately setting a magnitude of the electric field, the charged droplets 666 cause Rayleigh fission and ions of specific component may be generated. The charged droplets 666 and the ions are guided to the ion intake unit 63 by air flow and the electric field. Here, the oscillation of the probe 11 preferably includes a movement in a direction toward the ion intake unit 63 so that the electric field around the solution forming the Taylor cone 664 is changed in accordance with the oscillation of the probe 11. Furthermore, the ion intake unit 63 is preferably heated to a certain temperature in a range from a room temperature to several hundred ° C. By this, evaporation of the solvent from the small charged droplets 666 may be enhanced and ion generation efficiency may be improved.

Here, the Rayleigh fission means a phenomenon in which the charged droplets 666 reach Rayleigh limits and excess charges in the charged droplets 666 are discharged as secondary droplets. In general, when electrospray including the charged droplets 666 is generated from a tip of the Taylor cone 664 and the Rayleigh fission occurs, components included in the charged droplets 666 are generated as gas-phase ions. Furthermore, a threshold value voltage Vc for the generation of the electrospray is represented by the following equation: Vc=0.863(γd/ε₀)^{0.5} (here, “γ” denotes surface tension of the liquid, “d” denotes a distance between the liquid and the ion extraction electrode 631, and “ε₀” denotes vacuum permittivity) (J. Mass Spectrom. Soc. Jpn., Vol. 58, 139-154, 2010).

In this embodiment, the probe 11 is a unit for forming the liquid bridge 663 in the fine region on the surface of the sample 661 and a unit for forming the Taylor cone 664 for ionization. The apparatus 60 of this embodiment is characterized by selectively ionizing a substance included in the fine region on the surface of the sample 661 at high speed. The probe 11 is preferably oscillated at high speed so that the substance on the surface of the sample 661 is ionized at high speed.

Furthermore, the apparatus 60 of the present invention is characterized by controlling timings of generation and stop of the electrospray. Therefore, it is preferable that a timing when the liquid bridge 663 is formed between the free end 11b of the probe 11 and the sample 661 and a timing when the electrospray is generated are clearly separated from each other. By this, electrospray is not generated and only charges are supplied to the liquid forming the liquid bridge 663 while the liquid bridge 663 is formed. Thereafter, when an end portion of the probe 11 is moved close to the ion extraction electrode 631, electrospray is efficiently generated since the sufficient charges are accumulated in the liquid. To attain this effect, amplitude of the probe 11 is preferably increased.

Although the ionization under the atmospheric pressure has been described in this specification, the present invention is applicable to ionization under depressurization. Furthermore, the substance included in the sample 661 which is to be ionized by the apparatus 60 of this embodiment is not particularly limited. Since the apparatus 60 of this embodiment is capable of softly ionizing the substance included in the fine region under the atmospheric pressure, the apparatus 60 is suitably used in particular for ionization of a sample of a living body including a biological molecule, such as fat, sugar, or protein.

The apparatus 6 measures displacement of the probe 11 in accordance with the method described in the first embodiment or the second embodiment. When the probe 11 is oscillated, amplitude, a frequency, and a phase of the probe 11 are obtained. Such information associated with the displacement of the probe 11 is transmitted to the control unit 68.

The control unit 68 obtains the information associated with the displacement of the probe 11 and outputs a control signal to the XY control unit 611a, the Z control unit 611b, or the voltage applying device 1021 in accordance with the information. Specifically, in a case where the probe 11 is not oscillated by the oscillator 102, the control unit 68 outputs a control signal to the Z control unit 611b so that constant displacement of the probe 11 is attained. On the other hand, in a case where the probe 11 is oscillated by the oscillator 102, the control unit 68 outputs a control signal to the Z control unit 611b or the voltage applying device 1021 so that constant amplitude of the probe 11 is attained.

In this way, the control unit 68 preferably includes a feedback circuit. By performing the feedback control described above, the control unit 68 may perform control such that a stable oscillation state of the probe 11 is automatically maintained. Furthermore, oscillation timings of the probe 11 and the Z stage 61b may have a small time shift due to electrical capacitances of electrical wiring and components in an inside of the apparatus 60. In this case, a delay circuit may be provided for timing control in the feedback circuit so that the shift between the control signals and the shift between the actual oscillation timings of the probe 11 and the Z stage 61b are compensated for.

Such feedback control is particularly effective when ionization is performed on the sample 661 having a rough surface while the surface of the sample 661 is scanned by the probe 11 in an XY direction. In a case where ionization is performed while the probe 11 is oscillated, a period of time in which the liquid bridge 663 is formed and a period of time in which the Taylor cone 664 is formed may be maintained constant at all time in a cycle of the oscillation of the probe 11 by performing the feedback control described above. By this, the same ionization condition may be employed in XY coordinates on the surface of the sample 661. In the ionization by the apparatus 6, the substance to be ionized may be changed depending on a condition of dissolution of the sample 661 in the liquid bridge 663 and a condition of generation of electrospray. Therefore, the apparatus 6 may be stably operated when the same ionization condition is employed by performing the feedback control as described above.

Since the distance between the free end 11b of the probe 11 and the sample 661 is appropriately maintained, the free end 11b of the probe 11 is prevented from colliding with the sample 661 and damaging the sample 661.

Furthermore, since the feedback control is performed as described above, the scanning may be performed using the probe 11 along a rough structure on the surface of the sample 661. Specifically, according to the apparatus 60 of this embodiment, information on a surface profile of the sample 661 may be obtained by recording Z coordinates in accordance with the XY scanning of the probe 11.

The mass spectrometry apparatus 600 of this embodiment includes the apparatus 60 and the mass spectrometry unit 65. The mass spectrometry apparatus 600 may further include an ion counting unit 67, an image data generation unit 69, and a display unit 70.

The ion counting unit 67 may be incorporated in the mass spectrometry unit 65. Alternatively, the ion counting unit 67 may be externally connected to the mass spectrometry unit 65. In either case, the ion counting unit 67 obtains the number of ions transferred from the ion intake unit 63 and introduced into the mass spectrometry unit 65. Furthermore, the ion counting unit 67 incorporates an input terminal of a gate signal. By inputting an appropriate signal to the input terminal, driving of the ion counting unit 67 may be controlled.

As the ion counting unit 67, an ion detection device, such as a microchannel plate, and an electric signal measuring device (such as an analog-to-digital converter (ADC) or a time-to-digital converter (TDC)) may be used. Furthermore, a device for controlling a waveform of an electric signal (such as a discriminator or an amplification circuit) may be disposed between the ion detection device and the electric signal measuring device. Note that the input terminal of a gate signal included in the ion counting unit 67 is incorporated in the electric signal measuring device.

The control unit 68 has a function of specifying a portion to be ionized on the surface of the sample 661. In other words, the control unit 68 has a function of specifying a portion to be analyzed by the mass spectrometry unit 65 on the surface of the sample 661. The control unit 68 moves the sample 661 using the XY stage 61a and the Z stage 61b such that the substance included in the sample 661 existing in the specified portion is contained in the Taylor cone 664 through the liquid bridge 663.

Ions generated by the apparatus 60 are introduced into the mass spectrometry unit 65 through a differential exhaust system. Then the mass spectrometry unit 65 measures a mass-to-charge ratio of the ions. As the mass spectrometry unit 65, an arbitrary device, such as a quadrupole mass spectrometer, a time-of-flight mass spectrometer, a magnetic deflection mass spectrometer, an ion trap mass spectrometer, or an ion cyclotron mass spectrometer, may be used. Furthermore, a mass spectrum may be obtained by measuring the correlation between the ion mass-to-charge ratio (mass number/charge number) and an ion generation amount.

In general, the ion counting unit 67 intermittently receives trigger signals output from the mass spectrometry unit 65 and measures the number of ions after receiving the trigger signals. As the trigger signals, different signals are used in different structures of an ion separation unit included in the mass spectrometry unit 65.

In a case where a quadrupole mass spectrometer is used as the mass spectrometry unit 65, for example, a signal representing a timing when application of a high-frequency voltage to a quadrupole electrode is started is used as a trigger signal. Furthermore, in a case where a time-of-flight mass spectrometer is used as the mass spectrometry unit 65, a signal representing a timing when application of a pulse voltage is started to accelerate ions for measurement of a time of flight of the ions is used as a trigger signal. In a case where a magnetic deflection mass spectrometer is used as the mass spectrometry unit 65, a signal representing a timing when application of a magnetic field to a sector electrode is started is used as a trigger signal. In a case where an ion trap mass spectrometer is used as the mass spectrometry unit 65, a signal representing a timing when ions are introduced into an ion trap is used as a trigger signal.

The calculation unit 15 of this embodiment obtains a period of time in which a difference between voltage values represented by Expression (2) or Expression (3) is larger than a threshold value. The period of time obtained in this way is thought to correspond to a period of time in which the free end 11b of the probe 11 is positioned close to the ion extraction electrode 631 and a period of time in which the Taylor cone 664 is generated and ions are generated. Note that an arbitrary value may be set as the threshold value in accordance with a spring constant and a length of the probe 11 and amplitude of the oscillation applied by the oscillator 102. The calculation unit 15 outputs a signal indicating an ion generation timing for the obtained period of time to the control unit 68.

When a signal indicating the ion generation timing is input to the control unit 68, the control unit 68 outputs a voltage pulse to the input terminal of a gate signal of the ion counting unit 67. The ion counting unit 67 counts ions only while signals are input to the input terminal of a gate signal. Accordingly, the ion counting unit 67 may be operated only while ions are generated in the apparatus 60. Specifically, the control unit 68 controls an operation timing of the ion counting unit 67 in accordance with the displacement of the probe 11. Consequently, unnecessary measurement is not performed in a period of time in which ions are not generated. Here, the period of time in which ions are not generated specifically means a period of time in which the liquid bridge 663 is being formed or a period of time from when the liquid bridge 663 is formed to when the Taylor cone 664 is formed. By this, a noise signal included in obtained measurement data may be reduced and a size of the measurement data may be reduced.

Furthermore, since the ionization is performed after the XY control unit 611a controls the position of the XY stage 61a, a portion of the sample 661 included in the fine region in a specific XY coordinate may be ionized. Then the image data generation unit 69 integrates information on a position of the free end 11b relative to the sample 661 in the XY plane obtained when the ionization is performed (coordinates (X, Y)) and information on mass analyzed by the mass spectrometry unit 65 at this position (a mass spectrum) with each other. Specifically, the image data generation unit 69 generates mass image data which is 2D distribution data of the mass spectrum. Note that the data obtained in this method is 4D data constituted by a coordinate (X, Y) of the fine region and the mass spectrum (m/z, the number of ions).

In this way, by mapping an amount of ions based on an arbitrary mass-to-charge ratio to the XY plane in accordance with the obtained mass image data, image data representing a distribution of components of the mass-to-charge ratio may be generated. Accordingly, a distribution of a specific component on the surface of the sample 661 may be obtained. Alternatively, by performing multivariate analysis, such as principal component analysis and independent component analysis, on mass spectrum data, image data representing a substance, composition, a distribution of tissues included in the sample 661 may be generated. Note that the generation of the image data is performed by the image data generation unit 69.

The image data generation unit 69 further obtains Z coordinates on the surface of the sample 661 from a feedback control signal based on information on oscillation of the probe 11 input by the calculation unit 15, that is, an control amount of the Z control unit 611b. The image data generation unit 69 further obtains XY coordinates on the surface of the sample 661 from the control unit 68. The image data generation unit 69 integrates information on the Z coordinates and information on the XY coordinates with each other so as to generate image data (structure information) representing the surface profile of the sample 661. The image data generation unit 69 further generates 2D image data for image display in accordance with the 3D image data. For example, the image data generation unit 69 generates image data using different colors for different values in the Z coordinates or sliced image data obtained by slicing the 3D image data by an XY plane in an arbitrary Z coordinate.

The image data generated by the image data generation unit 69 is input to the image display unit 70, such as a flat panel display, for image display. Note that the image data may correspond to a 2D image or a 3D image. Furthermore, the image data may be output to an image forming unit, such as a printer, instead of the image display unit 70.

In image data representing a distribution of the substances or the like included in the sample 661, not only positions of the substances but also amounts of the substances may be also displayed. In this case, different amounts may be displayed by different colors or different brightness levels. Furthermore, in a case where different types of substances are included in the sample 661, the different types of substances may be displayed by different colors and different amounts of the different types of substances may be displayed by different brightness levels. Moreover, an optical microscope image of the sample 661 may be obtained in advance so as to be displayed in a state in which the optical microscope image is superimposed with the image generated by the mass spectroscopy apparatus 600 of this embodiment. In addition, an image representing the surface profile of the sample 661 (a roughness image) may be simultaneously displayed.

As described above, according to this embodiment, component distribution information of the sample 661 may be obtained and surface profile information of the sample 661 may be obtained.

### Example 1

Displacement of a probe is measured using the probe displacement measuring apparatus illustrated in FIGS. 1A to 1C.

A glass capillary having a cylinder hollow shape is used as the probe. A root portion (a fixed end side) of the probe is fixed on a piezoelectric element, and the probe is oscillated by oscillating the piezoelectric element.

To measure displacement of the probe, semiconductor laser light is emitted to a surface of the probe in a convergent manner, and reflected light of the semiconductor laser light is projected on a four-segment silicone photodiode (manufactured by Hamamatsu Photonics K.K., S5981) as a spot. Here, a light shielding plate is disposed on an optical path of the reflected light as illustrated in FIG. 1A. As the light shielding plate, a black plastic plate including a transmissive portion therein formed by cutting a portion of the plate in a slit shape is used. Here, the light shielding plate is disposed such that an angle defined by a longitudinal direction of the slit and a displacement direction of the spot is 10°.

When the reflected light is projected on the photodiode while the light shielding plate is not disposed, a spot of a parabolic band shape is obtained since a curved shape of the probe is reflected. In this example, a portion of the reflected light is extracted by arranging the light shielding plate described above, and a parallelogram spot is projected on the photodiode.

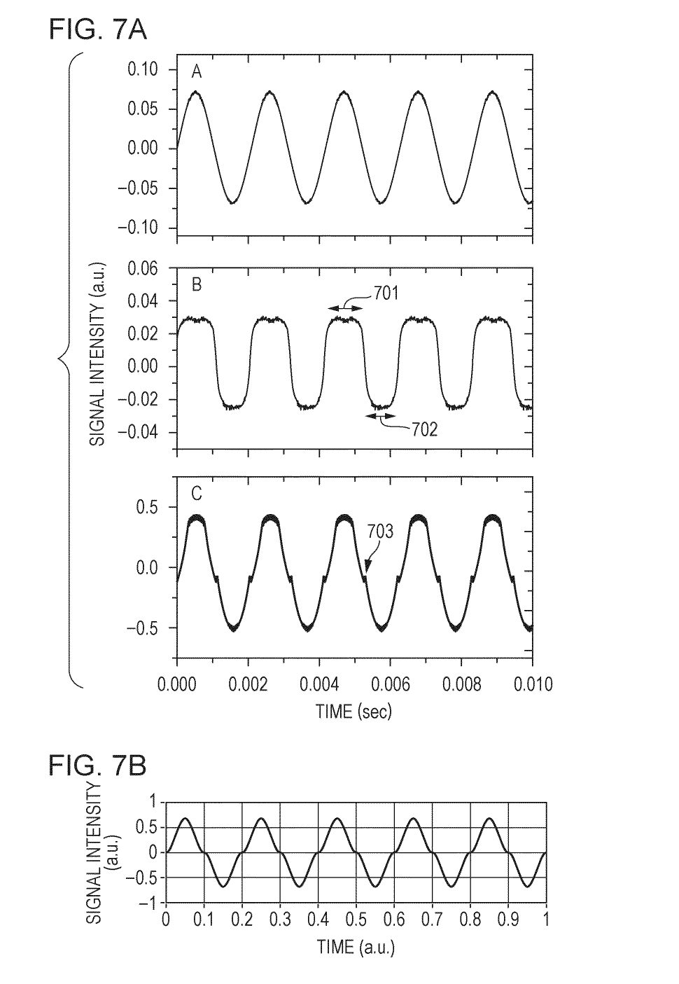

A voltage signal represented by Expression (3) is generated using two light receiving surfaces which are adjacent to each other among four light receiving surfaces of the photodiode. A result of measurement of displacement of the probe performed while the probe is oscillated is illustrated in FIG. 7A. FIG. 7A includes oscillographs representing results of the measurement of this example. In the oscillographs of FIG. 7A, horizontal axes denote time and vertical axes denote a voltage.

A signal A indicates an input signal to a piezoelectric element for probe excitation. As indicated by the signal A, a signal of a sine wave is input to the piezoelectric element.

A signal B indicates a voltage signal obtained when a voltage signal represented by Expression (3) is generated using pairs of light receiving surfaces which are adjacent to each other in a direction vertical to an oscillation direction of the probe. Specifically, the signal B corresponds to a result of a measurement using the general optical lever method. Furthermore, a signal C indicates a voltage signal obtained when a voltage signal represented by Expression (3) is generated using pairs of light receiving surfaces which are adjacent to each other in the oscillation direction of the probe. Specifically, the signal C corresponds to a result of the measurement according to the first embodiment.

Since the sine wave is input to the piezoelectric element for probe excitation, the oscillation of the probe is thought to be in a state similar to the sine wave. However, the signal B has a shape similar to a rectangular wave. Specifically, in the signal B, time regions in which a constant voltage value is obtained are generated as denoted by reference numerals 701 and 702. That is, in the signal B, displacement of the spot on the photodiode is not reliably obtained. However, amplitude of the probe in a larger range may be obtained also in the signal B when compared with a case where the measurement is performed without a light shielding plate.

On the other hand, a signal C has a waveform similar to a sine wave and a voltage value is changed in a cycle the same as a cycle of the signal A. However, the signal C is not a perfect sine wave and distortions 703 are observed as illustrated in FIG. 7A.

FIG. 7B is a graph illustrating a result of simulation of a voltage signal to be obtained after a model the same as that of the first example is generated. Consequently, a result the same as that of the signal C which is experimentally obtained is obtained. This is because intensity of the reflected light is varied depending on a position of a curved portion of the probe since a cylinder hollow probe is used, and the reflected light is extracted from a different reflection position by the light shielding plate.

As described above, using the light shielding plate having the slit which has the inclined longitudinal direction relative to the displacement direction of the probe, large displacement of the probe may also be measured.

### Example 2

A component distribution and structure information of a surface of a sample are simultaneously measured using the mass spectroscopy apparatus illustrated in FIG. 6.

Here, an oscillation state of a probe is measured using the probe displacement measuring apparatus of the first example. An amplitude value of a differential signal output from the probe displacement measuring apparatus is measured, and an oscillation state of the probe is measured while feedback control is performed so that a difference between an amplitude value set in advance and the actual amplitude value becomes zero. Information on a component distribution is obtained from an ion mass spectral measurement performed on positions of the probe on a sample and structure information is obtained from a feedback signal.

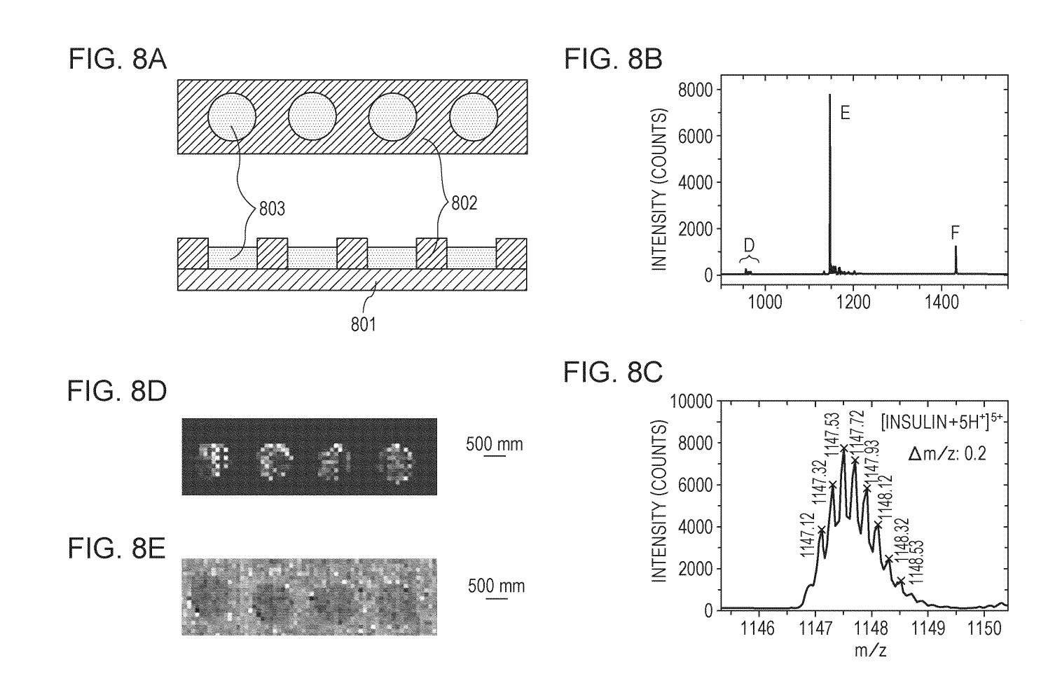

The used sample is schematically illustrated in FIG. 8A. The sample is generated by the following method. A substrate (manufactured by Matsunami Glass, Ind., Ltd) formed by forming a pattern 802 of a hydrophobic polymer film on a slide glass 801 is used. In this substrate, droplets of bovine insulin aqueous solution are applied to hole portions in which the slide glass 801 is exposed to an upper surface since the polymer film 802 is not disposed and the aqueous solution is dried by wind. A concentration of the insulin fluid used here is 1 mg/ml, and droplets of bovine insulin molecules of 85 pmol are applied to the holes. Note that the hydrophobic polymer film 802 has a thickness of approximately 20 micrometers, and insulin portions 803 obtained by being dried by wind have a thickness of approximately several micrometers.

A glass capillary (manufactured by New Objective, Inc., FS 360-50-5-N) is used as the probe, and mixed solvent of water, methanol, and formic acid is used as liquid to be supplied to the probe. Furthermore, it is assumed that an excitation frequency of the probe is 425 Hz. It is assumed that a scanning step of the probe on the surface of the sample is 100 micrometers. Furthermore, it is assumed that a voltage to be applied to the liquid is 4 kV, and a voltage to be applied to an ion extraction electrode in an ion intake unit is 30 V. Moreover, the ion intake unit is heated to 200° C., and a measurement of a mass spectrum is performed in a positive ion mode.

A mass spectrum obtained by adding mass spectra of ions obtained in the entire sample to one another is illustrated in FIG. 8B. As illustrated in FIG. 8B, three peak groups (D, E, and F) are observed. As a result of comparison with a database, the three peak groups correspond to multivalent ions, that is, hexahydric ions, pentavalent ions, and quadrivalent ions of the bovine insulin.

FIG. 8C is a graph illustrating the peak group E in an enlarged manner which has the largest signal intensity. In the peak group E, a plurality of isotope peaks are included in a range of a mass-to-charge ratio (m/z) from 1147 to 1149. Here, when a difference among mass-to-charge ratios of the peaks is calculated, 0.2 is obtained. Accordingly, the peak group E is pentavalent ions.

A 2D distribution image of the signal intensity of the pentavalent ions described above is illustrated in FIG. 8D. In FIG. 8D, portions corresponding to large signal intensity are represented by white. According to FIG. 8D, regions having large signal intensity have a circular shape, and therefore, it is recognized that insulin molecules included in the hole portions 803 on the substrate have been ionized.

Furthermore, the structure information (roughness information) of the sample is also measured simultaneously with the measurement of the component distribution. A result of the measurement is illustrated in FIG. 8E. In FIG. 8E, high portions of the surface of the sample are brighter and low portions are darker. Since circle patterns are located lower than the other portions, the hydrophobic polymer film and the hole portions are separately represented. Furthermore, when FIG. 8D and FIG. 8E are overlapped with each other, the circles are fit with each other, and accordingly, it is recognized that the component distribution information and the structure information may be simultaneously measured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-003580, filed Jan. 9, 2015, which is hereby incorporated by reference herein in its entirety.

What is claimed is:

1. A probe displacement measuring apparatus comprising:
a cantilever probe;
a light irradiation unit configured to irradiate the probe with light;
a light receiving element configured to receive reflected light obtained by reflecting light emitted by the light irradiation unit on a surface of the probe as a spot; and
a displacement obtaining unit configured to obtain displacement of the probe in accordance with a position of the spot on the light receiving element,
wherein the light receiving element has first and second light receiving surfaces divided by a straight division line, and
an angle defined by a displacement direction of the spot on the light receiving element and the division line is 0° or more and 90° or less.

2. The probe displacement measuring apparatus according to claim 1, wherein the displacement obtaining unit obtains a position of the spot on the light receiving element in accordance with a difference between an amount of light received by the first light receiving surface and an amount of light received by the second light receiving surface.

3. The probe displacement measuring apparatus according to claim 1, further comprising:
a light shielding unit configured to block a portion of the reflected light and disposed on an optical path of the reflected light.

4. The probe displacement measuring apparatus according to claim 3, wherein the light shielding unit has a slit which allows a portion of the reflected light to pass and an angle defined by a straight line which is parallel to a longitudinal direction of the slit and the division line is larger than 0° and smaller than 90°.

5. The probe displacement measuring apparatus according to claim 1, wherein a plane in which displacement of the probe obtained by the displacement obtaining unit is generated is parallel to the division line.

6. The probe displacement measuring apparatus according to claim 1, wherein a center axis of the probe and the division line are included in the same plane.

7. The probe displacement measuring apparatus according to claim 4, wherein a plane in which displacement of the probe obtained by the displacement obtaining unit is generated is parallel to the straight line which is parallel to the longitudinal direction of the slit.

8. The probe displacement measuring apparatus according to claim 4, wherein a center axis of the probe and a center line which is parallel to the longitudinal direction of the slit are included in the same plane.

9. The probe displacement measuring apparatus according to claim 1, wherein a sum of an amount of light received by the first light receiving surface and an amount of light received by the second light receiving surface is constant irrespective of displacement of the spot on the light receiving element.

10. The probe displacement measuring apparatus according to claim 9, wherein the amount of light received by the first light receiving surface and the amount of light received by the second light receiving surface are individually changed in accordance with displacement of the spot on the light receiving element.

11. The probe displacement measuring apparatus according to claim 4, wherein assuming that an angle defined by a displacement direction of the spot on the light receiving element and the division line is denoted by “θ1”, θ1 satisfies Expression (1) below:
0°<θ1<tan⁻¹(X/(L−Y)) Expression (1)
(here, “X” denotes a width of the slit, “Y” denotes a length of the spot in the displacement direction of the spot, and “L” denotes a width of the displacement of the spot.

12. An ionization apparatus comprising:
the probe displacement measuring apparatus set forth in claim 1; and
an ionization unit configured to ionize a substance included in a fine region on a surface of a sample by bringing a free end of the probe close to or in contact with the fine region.

13. The ionization apparatus according to claim 12, further comprising:
a distance changing unit configured to change a distance between the probe and the sample in accordance with displacement of the probe obtained by the displacement obtaining unit.

14. The ionization apparatus according to claim 13, wherein the distance changing unit changes a distance between the probe and the sample so that displacement or amplitude of the probe obtained by the displacement obtaining unit becomes constant.

15. The ionization apparatus according to claim 12, wherein
the ionization unit includes
a liquid supplying unit configured to supply liquid to the free end,
an extraction electrode configured to extract ions generated when the substance is ionized, and
an electric field generation unit configured to generate an electric field in a portion between the free end and the extraction electrode.

16. A mass spectrometry apparatus comprising:
the ionization apparatus set forth in claim 12; and
an analysis unit configured to analyze mass of the ionized substance.

17. The mass spectrometry apparatus according to claim 16 which controls an operation timing of ion counting performed by the analysis unit in accordance with the displacement of the probe obtained by the probe displacement measuring apparatus.

18. The mass spectrometry apparatus according to claim 16, further comprising:
an XY scanning unit configured to relatively perform scanning on the probe and the surface of the sample in an XY direction.

19. The mass spectrometry apparatus according to claim 18, further comprising:
an image data generation unit configured to generate first image data representing a distribution of a component included in the sample in accordance with information on the mass analyzed by the analysis unit and information on a position of the probe on the XY plane relative to the sample obtained when the mass information is obtained.

20. The mass spectrometry apparatus according to claim 19, wherein the image data generation unit generates second image data representing a surface profile of the sample in accordance with information on the position of a free end of the probe on an XY plane relative to the sample and a control amount of the distance changing unit.
